(19) United States
(12) Patent Application Publication
(10) Pub. No.: US 2025/0103345 A1
(43) Pub. Date: Mar. 27, 2025

(54) APPARATUS, METHOD, AND NON-TRANSITORY MACHINE-READABLE STORAGE MEDIUM INCLUDING FIRMWARE FOR AN APPARATUS

(71) Applicant: Intel Corporation, Santa Clara, CA (US)

(72) Inventors: Ming WU, Shanghai (CN); Addicam V SANJAY, Gilbert, AZ (US); Fujin HUANG, Shanghai (CN)

(21) Appl. No.: 18/656,647

(22) Filed: May 7, 2024

(30) Foreign Application Priority Data
Jan. 30, 2024 (WO) PCT/CN2024/074617

(51) Int. Cl. G06F 9/4401

(52) U.S. Cl. CPC G06F 9/4406

(57) ABSTRACT

It is provided an apparatus comprising interface circuitry, machine-readable instructions, and processing circuitry to execute the machine-readable instructions. The machine-readable instructions comprise instructions to obtain a first data structure, the first data structure indicating which data block of a block-based core system image is available in a local storage circuitry. The machine-readable instructions further comprise instructions to check, during loading of at least one component of a software, if a data block required during execution of the software is available in the local storage circuitry according to the first data structure. The machine-readable instructions further comprise instructions to obtain the data block from a server if the required data block is not available, wherein the server is storing a copy of the core system image.

### BACKGROUND

Often, IT administrators want to onboard numerous bare metal client devices for employees with pre-configured operating systems, corporate-required application software, and corporate system settings such as background images, screen savers, and firewall policies. Additionally, IT administrators often want to update employees' software systems by applying operating system security patches or upgrading existing application software. Furthermore, with the increasing deployment of edge servers in cloud environments, edge nodes may also be regarded as cloud client devices from the cloud's perspective. Thus, the onboarding, upgrading, management, and recovery of systems in multiple edge nodes at geographically dispersed locations may present a challenge. However, system onboarding, updating, or upgrading can take several hours, or even several days, for each device. Therefore, improving the latency of system software onboarding or updating may be desirable.

### BRIEF DESCRIPTION OF THE FIGURES

Some examples of apparatuses and/or methods will be described in the following by way of example only, and with reference to the accompanying figures, in which

FIG. 1 illustrates a block diagram of an example of an apparatus or device;

FIG. 2 illustrates a boot flow comparison of a native PC and a zero-latency approach as described in this disclosure;

FIG. 3 illustrates an example of a schematic illustration of an internal architecture of a zero-latency onboarding a device;

FIG. 4 illustrates an example of a flowchart of the zero-latency read and write method;

FIG. 5 illustrates a layer of a system image;

FIG. 6 illustrates an example of a flowchart of an operating system level read/write method;

FIG. 7 illustrates an example workflow of the described technique:

FIG. 8 shows an example of a workflow of a user migration from one device to another device;

FIG. 9 illustrates non-transitory machine-readable storage medium including firmware for an apparatus; and

FIG. 10 illustrates a flowchart of an example of a method.

### DETAILED DESCRIPTION

Some examples are now described in more detail with reference to the enclosed figures. However, other possible examples are not limited to the features of these embodiments described in detail. Other examples may include modifications of the features as well as equivalents and alternatives to the features. Furthermore, the terminology used herein to describe certain examples should not be restrictive of further possible examples.

Throughout the description of the figures same or similar reference numerals refer to same or similar elements and/or features, which may be identical or implemented in a modified form while providing the same or a similar function. The thickness of lines, layers and/or areas in the figures may also be exaggerated for clarification.

When two elements A and B are combined using an “or”, this is to be understood as disclosing all possible combinations, i.e. only A, only B as well as A and B, unless expressly defined otherwise in the individual case. As an alternative wording for the same combinations, “at least one of A and B” or “A and/or B” may be used. This applies equivalently to combinations of more than two elements.

If a singular form, such as “a”, “an” and “the” is used and the use of only a single element is not defined as mandatory either explicitly or implicitly, further examples may also use several elements to implement the same function. If a function is described below as implemented using multiple elements, further examples may implement the same function using a single element or a single processing entity. It is further understood that the terms “include”, “including”, “comprise” and/or “comprising”, when used, describe the presence of the specified features, integers, steps, operations, processes, elements, components and/or a group thereof, but do not exclude the presence or addition of one or more other features, integers, steps, operations, processes, elements, components and/or a group thereof.

In the following description, specific details are set forth, but examples of the technologies described herein may be practiced without these specific details. Well-known circuits, structures, and techniques have not been shown in detail to avoid obscuring an understanding of this description. “An example/example,” “various examples/examples,” “some examples/examples,” and the like may include features, structures, or characteristics, but not every example necessarily includes the particular features, structures, or characteristics.

Some examples may have some, all, or none of the features described for other examples. “First,” “second,” “third,” and the like describe a common element and indicate different instances of like elements being referred to. Such adjectives do not imply element item so described must be in a given sequence, either temporally or spatially, in ranking, or any other manner. “Connected” may indicate elements are in direct physical or electrical contact with each other and “coupled” may indicate elements co-operate or interact with each other, but they may or may not be in direct physical or electrical contact.

As used herein, the terms “operating”, “executing”, or “running” as they pertain to software or firmware in relation to a system, device, platform, or resource are used interchangeably and can refer to software or firmware stored in one or more computer-readable storage media accessible by the system, device, platform, or resource, even though the instructions contained in the software or firmware are not actively being executed by the system, device, platform, or resource.

The description may use the phrases “in an example/example,” “in examples/examples,” “in some examples/examples,” and/or “in various examples/examples,” each of which may refer to one or more of the same or different examples. Furthermore, the terms “comprising,” “including,” “having,” and the like, as used with respect to examples of the present disclosure, are synonymous.

As described above, the system onboarding of an apparatus or device or updating or upgrading software running on the apparatus or device may take a long time (for example several hours, or even several days) for each device. Onboarding of an apparatus or device or may refer to configuring the apparatus or device with necessary software. That is the remote onboarding or updating of bare metal client devices (PC, IoT embedded platform or edge nodes) may have a long latency. Further, the restoring of client devices from remote, even when local storage was damaged, may not be possible without long latencies. Furthermore, migrating an entire software system to another bare metal may have very long latencies until the migrated system is available again.

In the following some examples are given, where currently onboarding or updating may have a high latency and may cause problems for the user. For example, a teacher may not boot his computer accidently just before an important class. He hoped to quickly onboard his personalized software system on a borrowed hardware to continue with the class as soon as possible. However, this process may take too long. In another example, an employee may want to remote dial-in to a tele-conference, however he finds his laptop running into “blue screen”, due to physical damage of local storage. He would like to restore the system immediately which may take too long. In yet another example, a city traffic authority may want to upgrade a system software of several hundreds of smart cameras remotely to enable a new algorithm (for example an AI traffic violation capture algorithm). However, the booting of the new software together with local system refresh may take too long and cause a too long interruption time. In another example, a cloud service provider may want to onboard and/or upgrade dozens of newly deployed edges nodes located in different regions with a latest system software, from adjacent edge nodes that could help. However, this process may take too long.

There are several previous approaches for the above described problem. For example, in some approaches a manual installation and updating of system software one by one may be done. For example, a system administrator may install an entire operating system and application software to bare-metal client either at local or from remote in order to onboard the client devices. However, it may be not efficiently to handle each client manually one by one and may be an inconvenient approach to onboard multiple devices or a large number of geographically dispersed devices quickly just like traffic camera scenarios.

In some other approaches the onboarding and/or updating may be based on a virtual desktop infrastructure (VDI) or thin client approach by centrally managing system software at cloud. A VDI may be a technology that hosts desktop environments on a centralized server, allowing users to access their desktops over a network from any device. A thin client may be a lightweight computer that relies on a server to perform most of its computational tasks and often lacks local storage, relying on network connectivity to access applications and data. In this approach, multiple virtual machines (VMs) may be hosted at a cloud, and each remote user (client) may be assigned with an individual VM by streaming the VM output to the remote thin client box. The end user may manipulate the virtual machine instance just like he may manipulate a local system. The remote onboarding of a VM may be done by duplicating an VM image and on-demand load this VM image for different users at remote. However, the operating system (OS) may not be running at the local client, therefore there may be a reduced performance and experience at client side because the VM output may be transported to the local thin client box via a network connection (i.e., the remote VM output will be streamed to local thin client box). In other words, the user experience at client side is dependent on network connection during the entire OS run-time period. If network is not reliable or congested or disconnected, the user experience may be bad. For example, in a WAN environment with narrow bandwidth these issues may increase. Further, there may arise compatibility issues when making the local connected peripherals work with remote virtual machine, such as ID card read, camera, old printers etc., which are quite usual for vertical customers.

In some other approaches the onboarding and/or updating may be based on disk cloning and/or ultra cloud client (UCC), such as a rich-client system onboarding by deploying and loading OS images. A disk cloning software (such as the disk cloning program “Ghost”) may dump an entire hard disk or a partition to an image file from the golden machine and copy the image back to the target client. Further, UCC technology may make an entire OS and applications to run on top of a chain of incremental based virtual disk images and deploy the image during pre-boot period. The onboarding and updating of client devices may be equal to the update of a system image file during a pre-boot period. However, in this approach a huge disk image must be provisioned from server to client and all images have been provisioned before OS can boot. The size of an image may be huge (several dozen gigabytes for an OS like Window® 11 or Ubuntu), therefore the latency caused by image deployment is very long (e.g., 20 minutes for an 80G image in a broadband 1000BaseTX network environment). Therefore, the latency may be too long and not acceptable in many cases.

In some other approaches the onboarding and/or updating may be based on a network based remote recovery for client devices or edge nodes. For example, the network based remote recovery may be based on image cloning, saving images to remote and restoring a client/edge system through a network connection. The image to be deployed may be shared between different client/edge nodes. This may be used for deploying a uniform system image to multiple clients but may not be flexible enough for on demand deploying non-uniform personalized system images to different client platforms or edge nodes. Further, the client device may not boot until the complete OS image is deployed (dumped) to the local client storage in this approach. Therefore, the boot latency may be too long because client devices cannot boot until huge OS image is fully deployed from remote. Also, addressing system recovery issues by sharing images between nodes and edges may cause problems because the recovery speed from long-haul network connection is not satisfactory and may became more challenging in a WAN backbone environment with hundreds even thousands edge nodes. Further, it may lack advanced features like system rollback/restore and upgrade/update. Therefore, in this approach the long recovery and boot latency may cause problems.

In the present disclosure a generic zero-latency approach to onboard cloud client devices or edge nodes with remote centrally managed system image is proposed. The onboarding may be based on an “on-the-fly” system booting and running mechanism other than the previous approaches as described above. The present disclosure proposes to store and centrally manage an entire system image at remote and set up a local storage at client device to cache latest-used data blocks of the system image (for example the core system image). Further, it is proposed to run the client device on top of the system images and cache latest-used data blocks of the system image at client device during OS booting and running with the system image being stored at the remote (edge) server. In some examples a pre-boot level read-write agent (BRWA) may be included into the BIOS of the client in order to fetch data blocks during booting period as described above. Further, in some examples an OS-level read-write agent (ORWA) may handle run-time data block input/output from either remote or local storage at the OS level

The present disclosure proposes a zero-latency onboarding of client devices by “on-the-fly” booting and running the system image from an adjacent edge in a LAN. For example, the distinction between network based remote backup & restore as described above and the present disclosure is that the present zero-latency approach does not copy the entire image to local before it starts booting, but on demand retrieves the required data block during boot. Therefore, the system may boot block by block on-the-fly. In some examples, the latest used data blocks may be Continuously cached for future use. Furthermore, the system images may be centrally managed by a cloud and provisioned by an adjacent (edge) server to further reduce the network latency. That is, in some examples the data provisioning (data plane) is carried out through an adjacent edge server, which is however managed by the remote cloud (control plane)). This is also referred to as edge-cloud collaboration which may further accelerate the latency. For example, if data blocks are cached at local storage they are read from local storage and otherwise the data block may be read from the remote (edge) server. If no blocks are at stored at the local storage, all blocks are from read from remote and the booting is still done on-the-fly with zero latency. In some examples, the (edge) server may provide the data block input/output service with its stored system image which is accessed through LAN with guaranteed bandwidth and latency, however the control of the (edge) sever(s) may be managed by the cloud.

In some examples the entire client software image may comprise the core system image and a user image. In some examples, the core system image may be block-based, and the user image may be file-based. The present disclosure further proposes the file system layer (file-based user image) to be overlayed on the “on-the-fly deployed” images for personalization. For example, the (core) system image may be pre-configured by a system administrator, and the user image may be overlayed on the top with private software applications and data of a specific end user. Further, a client software image may be dynamically combined during OS booting and running. The present disclosure further proposes to migrate a user environment by migrating the user image only. For example, in this case the system image may be streamed from the remote server with cloud-edge collaboration as described above.

The proposed technique may provide an instant, zero-latency onboarding and updating and restoring of bare metal client devices for end users. Further, the present disclosure allows to keep a native hardware experience with a high performance and good user experience. Further, the proposed technique ensures a peripheral compatibility (such as graphics, audio, USB camera etc.) as the operating system is running on native hardware instead of being run on the server. Further, the proposed technique increases the security and reliability of client system and user data with the system images which are stored at the cloud/edge and even available of the client local storage is damaged.

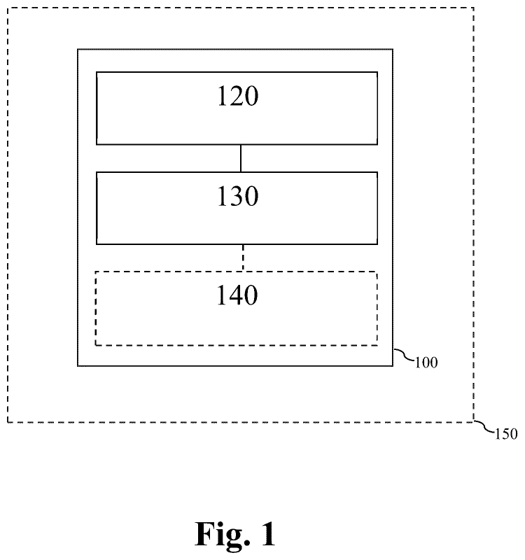

FIG. 1 illustrates a block diagram of an example of an apparatus 100 or device 100. The apparatus 100 comprises circuitry that is configured to provide the functionality of the apparatus 100. For example, the apparatus 100 of FIG. 1 comprises interface circuitry 120, processing circuitry 130 and (optional) storage circuitry 140. For example, the processing circuitry 130 may be coupled with the interface circuitry 120 and optionally with the storage circuitry 140.

For example, the processing circuitry 130 may be configured to provide the functionality of the apparatus 100, in conjunction with the interface circuitry 120. For example, the interface circuitry 120 is configured to exchange information, e.g., with other components inside or outside the apparatus 100 and the storage circuitry 140. Likewise, the device 100 may comprise means that is/are configured to provide the functionality of the device 100.

The components of the device 100 are defined as component means, which may correspond to, or implemented by, the respective structural components of the apparatus 100. For example, the device 100 of FIG. 1 comprises means for processing 130, which may correspond to or be implemented by the processing circuitry 130, means for communicating 120, which may correspond to or be implemented by the interface circuitry 120, and (optional) means for storing information 140, which may correspond to or be implemented by the storage circuitry 140. In the following, the functionality of the device 100 is illustrated with respect to the apparatus 100. Features described in connection with the apparatus 100 may thus likewise be applied to the corresponding device 100.

In general, the functionality of the processing circuitry 130 or means for processing 130 may be implemented by the processing circuitry 130 or means for processing 130 executing machine-readable instructions. Accordingly, any feature ascribed to the processing circuitry 130 or means for processing 130 may be defined by one or more instructions of a plurality of machine-readable instructions. The apparatus 100 or device 100 may comprise the machine-readable instructions, e.g., within the storage circuitry 140 or means for storing information 140.

The interface circuitry 120 or means for communicating 120 may correspond to one or more inputs and/or outputs for receiving and/or transmitting information, which may be in digital (bit) values according to a specified code, within a module, between modules or between modules of different entities. For example, the interface circuitry 120 or means for communicating 120 may comprise circuitry configured to receive and/or transmit information.

For example, the processing circuitry 130 or means for processing 130 may be implemented using one or more processing units, one or more processing devices, any means for processing, such as a processor, a computer or a programmable hardware component being operable with accordingly adapted software. In other words, the described function of the processing circuitry 130 or means for processing 130 may as well be implemented in software, which is then executed on one or more programmable hardware components. Such hardware components may comprise a general-purpose processor, a Digital Signal Processor (DSP), a micro-controller, etc.

In some examples, the apparatus 100 may be connected (for example via the interface 120) to or be included in a computing system 150 (such as a PC, or laptop, or smartphone or the like). For example, the apparatus 100 and/or the computing system may be a client device (see below). The apparatus 100 and/or computing system 150 may run an operating system and execute software based on the processing circuitry 130.

The processing circuitry 130 is configured to obtain a first data structure. The first data structure indicates which data block of a block-based core system image is available in a local storage circuitry. In some examples, the local storage circuitry is the storage circuitry 140. In some examples the apparatus 100 may comprise the local storage circuitry. In some examples computing system may comprise the local storage circuitry. For example, the local storage circuitry is local to the processor circuitry 130. That is, the local storage is for example physically located in proximity to the processor circuitry 130, such as being located within the same computing system (such as the same PC, or laptop or smartphone or the like).

The core system image may be a part of or a full copy of a system image. The system image may be a copy of the entire state of a computer system, for example the computer system running on the of the apparatus 100 and/or computing system 150 in which the processing circuitry 130 and the local storage circuitry are included. For example, the core system image comprises at least one of an operating system, a system driver, or pre-installed application software running on the computing system in which the processing circuitry 130 and the local storage circuitry are included. Further, the core system image is block-based, which means the stored data is organized by dividing it into fixed-size blocks. Each block may be treated as an independent unit, with its own address and metadata. Unlike file-based storage, which organizes data into files and directories, and object-based storage, which stores data as discrete objects with unique identifiers, block-based storage may operate at a lower level, providing direct access to specific blocks of data in the physical storage circuitry.

The first data structure may indicate which block of the core system image is stored in the local storage circuitry and locally and fast available to the processing circuitry 130. In some examples the first data structure may be determined based on the data blocks available at the local storage circuitry. For example, the processing circuitry 130 may access the metadata associated with the core system image. The metadata may include a block allocation table or a similar structure, which provides detailed information on the allocation status of each data block, indicating whether they are available in the local storage circuitry or not. The processing circuitry 130 may periodically or continuously update the allocation table to reflect real-time changes as blocks become occupied or freed. Based on the allocation table the first data structure may be generated to indicate which block is available. For example, the data first structure may comprise one bit for each block of the core system image and indicates by that bit if corresponding block is available in the local storage. In some examples the first data structure (also the second and the third data structure, see below) may be bitmap. In other examples, the data structure (also the second and the third data structure, see below) may be an array, or a list or the like. In some examples, the first data structure may be empty, for example if there are no stored blocks at local storage circuitry so far.

The processing circuitry 130 is configured to check, during loading of at least one component of a software, if a data block required during execution of the software is available in the local storage circuitry according to the first data structure. The software may comprise one or more components. The software components may be distinct, integral parts that constitute the software, enabling it to function effectively and perform the tasks it's designed for. For example, the software may comprise an executable component (also referred to as executable), which may be the code that is executed by the processing circuitry 130 in order to run the software. Further, the software may comprise components, which are utilized (for example read from/write to) during runtime. Said components may comprise libraries, frameworks, runtime environments, dependencies, configuration files, plugins, extensions or the like. All components may be required during execution, which may refer to the execution of the executable files as well as the components utilized during runtime. That is, in some examples, the at least one component of the software may comprise executables of the software. In some examples, at least one component of the software may comprise data which is used by the software to read/write.

In some examples the at least one component of the software may be an operating system, a system driver, a pre-installed application software, an application, personalized user settings, and/or a firewall policy or the like. Said components may comprise executable components and/or runtime components.

Checking during loading if a data block is available in the local storage may refer to the processing circuitry 130 starting the loading of the software or of the at least one software component before it made sure that all data blocks of the software or of the at least one software component are available in the local storage. Instead, the checking if the specific data block is available in the local storage is done when said data block is actually required during execution, for example when it is actually loaded. A data block that is required during execution may refer to a data block that is required in the phase of the execution of the executable components and/or a data block that is require in the phase of loading/reading the runtime components. In other words, the processing circuitry may on-the-fly check if a required data block is available when said data block is required or right before that moment.

In some examples, the at least one software component may comprise an operating system. The processing circuitry 130 may be configured to check, during booting an operating system, if the data block required for booting the operating system is available in the storage circuitry according to the first data structure. In some examples, the at least one component of the software is loaded during runtime of the operation system. For example, the at least one component is an application or the like that is loaded and executed after the booting has finished, that is during runtime of the operating system.

The checking if the required data block is available in the local storage is done by using the first data structure. For example, the corresponding bit or entry in the first data structure corresponding to the required data block is examined. In case that the checking if the required data block is available in the local storage yields that the required data block is indeed available in the local storage, then the required data block is loaded from the local storage (local storage may be a local hard disk).

The processing circuitry 130 is configured to obtain the data block from a server if the required data block is not available. The server is storing a copy of the core system image. That is in case that the checking if the required data block is available in the local storage yields that the required data block is not available in the local storage, then the required data block is obtained from the server. For example, the processing circuitry 130 may issue a request via the interface circuitry 120 to the server that it needs the required data block, and the server may transmit the required data block to the apparatus 100 and/or the processing circuitry 130 as response. For example, the processing circuitry 130 may be configured write the data block obtained from the server to the local storage circuitry and store it there. Next time the processing circuitry 130 may require that data block it may read it from the local storage circuitry. In some examples, the processing circuitry 130 may be configured to update the first data structure, indicating that the written data block is now available in the local storage circuitry.

In the other case, the checking if the required data block is available in the local storage yields that the required data block is indeed available in the local storage circuitry according to the tracking data structure, the processing circuitry 130 is configured to read the required data block from the storage circuitry.

Therefore, the above described technique may enable an instant, zero-latency onboarding of the apparatus 100 and/or the computing system 150. That is because the apparatus 100 and/or the computing system 150 may start the booting of an operation system right away without waiting until the complete operation system is fully received at the local storage. Accordingly, the above described technique may enable an instant, zero-latency installing, updating, upgrading, and/or restoring of software running on apparatus 100 and/or the computing system 150. Further, the present disclosure allows to keep a native hardware experience and a high performance and good user experience while operating the apparatus 100 and/or computing system 150 because the processing is carried out locally by the processing 130 instead of remotely by a server. Further, the proposed technique ensures a compatibility of peripherals (such as graphics, audio, USB camera etc.) as the operating system is running on native hardware of the apparatus 100 and/or computing system 150 instead of being run on the server. Further, the proposed technique increases the security and reliability of apparatus 100 and the user data because it is stored at the server and is instantly available if the local storage is damaged.

In some examples, the processing circuitry 130 may be configured to obtain a second data structure from the server. The second data structure indicates which data block of the core image system stored at the local storage circuitry is to be updated if a data block of the core system image is to be updated. For example, a part of the operating system or a part of a driver or a part of an application software is updated, and the server comprises the updated blocks and wants to distribute the updated blocks to a plurality of client devices comprising the apparatus 100. Then the server may generate second data structure, which may have an identical format and size as the first data structure. For example, the second data structure comprises one bit for each block of the core system image and indicates which of the bits is to be updated at the local storage circuitry. The server may transmit the second data structure to the apparatus 100, where it is obtained.

In some examples, the processing circuitry 130 may be configured to determine the first data structure based on the second data structure. For example, after obtaining the second data structure the processing circuitry 130 marks all data blocks in the first data structure as being not available, which are indicated as to be updated in the second data structure. In some examples, the processing circuitry 130 may be configured to determine the first data structure based on the second data structure and on the data blocks available at the local storage circuitry. As described above the processing circuitry 130 may determine the first data structure based on available data blocks based on the metadata associated with the core system image and the obtained block allocation table. Further, blocks that are to be updated as indicated in the second data structure, may be removed from the local storage, and may be marked as being not available in the first data structure. For example, if the first data structure and the second data structure are bitmaps. Then all bits in the first data structure may be cleared corresponding to the bits which are set the second data structure (indicating data blocks to be updated). For example, the storage space which stores the corresponding data block in the local storage circuitry that is to be updated may be freed, that is the data block may be removed from the local storage circuitry.

In some examples, the processing circuitry 130 may be configured to clear the data block from the local storage circuitry which is indicated in the second data structure to be updated. That is, the storage space which stores the corresponding data block in the local storage circuitry that is to be updated may be freed, that is the data block may be removed from the local storage circuitry.

In some examples, the processing circuitry 130 may be configured to write the data block obtained from the server to the local storage circuitry. In case that the obtained data block is updated, for example the data block may be written at the storage space that was freed up by removing the outdated data block.

In some examples, the processing circuitry 130 may write a data block to the local storage. In some examples, the processing circuitry 130 may be configured to determine a third data structure. The third data structure may indicate data blocks that were updated in the local storage circuitry. In some examples, only the data blocks that where not received from the server to be updated but that were generated by the processing circuitry 130 during executing of the software are indicated as updated data blocks in the third data structure.

In some examples, during execution of the software, the software may write to local storage circuitry without a preceding read request. This may involve both the creation of new data and/or the updating of existing data. For instance, the program might persist fresh user settings or application state across sessions, record newly generated operational data in log files, enhance performance by caching recently accessed data, manage complex operations with the creation of temporary files, download and store new updates or patches, and execute database transactions that update existing records with new information etc. In these cases, since there is no preceding read request to the server, the server may not have any knowledge about the newly written data. Therefore, in order to have the system image being synchronized between the server, the third data structure is generated by the processing circuitry 130. Further, the processing circuitry 130 may be configured to transmit the third data structure to the server. In some examples, the processing circuitry 130 may be further configured to transmit the data blocks to the server such that the server keeps track of a synchronized system image of the system image (for example the core system image) of the apparatus 100. For example, the third data structure may be transmitted to the server at regular intervals. In some examples, the during OS run-time, the third data structure is not send back to the server. Instead, the third data structure may be sent back to the server after the after the apparatus is shut down, together with the corresponding updated data blocks to refresh that core system image at the server.

In some examples, the complete system image of the computer system running on the of the apparatus 100 and/or computing system 150 in which the processing circuitry 130 and the local storage circuitry are included further comprise a user image. In some examples, the user image may comprise user-specific data. For example, the user image may comprise user-related application software. For example, the user image, may comprise user-specific data, including personal files, settings, and applications, allowing for more granular data management. In some examples, the user image may be file-based.

In some examples, complete system images may consist of the core system image and the user image. That is, it may operate at a higher level of abstraction that interacts with the file system rather than raw storage blocks. The file-based layer may enable individual file access, selective backups, and personal configuration adjustments, providing flexibility and convenience for end-user data management. The integration of two images, block-based core system image and file-based user image, may offer a full spectrum of data from the system's core operational environment to the user-customized content. In some examples, the user image may be fully stored in the local storage circuitry.

In some examples, the processing circuitry 130 may configured to check if requested data is a data block which is part of the block-based core system image or if the requested data is part of the file-based user image. For example, of the required data block is part of the file-based user image, then the processing circuitry 130 knows that the required data is stored locally. If the required data is part of the block-based core system image, then the processing circuitry 130 may proceed as described above and may check the local availability of the required data.

In some examples file-based user image may be overlayed on the “on-the-fly deployed” images for personalization. For example, the core system image may be pre-configured by a system administrator, and the user image may be overlayed on the top with private software applications and data of a specific end user. Further, the core user image may be dynamically combined during OS booting and running. For example, if the system is migrated from the apparatus 100 to another apparatus, then the only user image may have to migrate to the other apparatus. The core system image may be obtained as described above by checking which blocks are available and by obtaining the required data blocks from the server. This may

the user image only. For example, in this case the system image may be streamed from the remote server with cloud-edge collaboration as described above. This creates a high degree of flexibility and facilitates and accelerates migration from one apparatus to another.

In some examples, the apparatus 100 and/or the computing system 150 may be a client device or part of a client device which may be connectable (for example via the interface 120) to the server. For example, the server may be an edge server and the apparatus 100 may be connected to the edge server. A network architecture may comprise a central cloud server, one or more edge servers and a plurality of client devices. For example, the central cloud server provides computing resources and storage which is centralized in data centers managed by a cloud service provider, allowing for efficient global data access and management. One or more edge servers may be positioned at the network's periphery one or more near client devices, handle local data processing to minimize latency and manage bandwidth by performing real-time tasks that reduce the need for data to travel to and from the central servers.

For example, the edge server may be managed and controlled by the cloud. The edge server may carry out the data plane wherein the cloud may carry out the control plane. For example, an update of a software should be rolled out to a plurality of client devices, including the apparatus 100. Therefore, as described above, a second data structure may be generated indicating which data blocks of the core system image at the plurality of client devices should be replaced and updated. The cloud may be controlled to transmit a copy of the second data structure to all of the one or more edge servers and may control them to distribute a copy of the second data structure to each client connected to the respective edge server. Each client device may be than carry out the technique as described above and replace the updated data blocks on the fly. The same may be true of plurality of client devices is onboarded. Thereby, a plurality of client devices may be updated and/or onboarded very fast with low latency and controlled by the cloud (which may be controlled by an IT administrator).

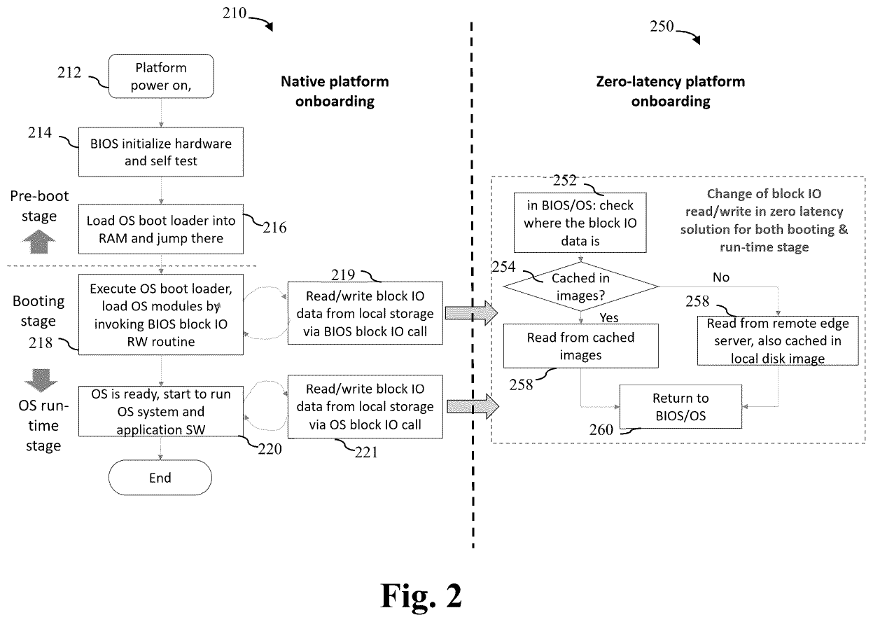

Further details and aspects are mentioned in connection with the examples described below. The example shown in FIG. 1 may include one or more optional additional features corresponding to one or more aspects mentioned in connection with the proposed concept or one or more examples described below (e.g., FIGS. 2-10).

### Example of the Zero-Latency Onboarding and/or Updating

In the following an example of the above described technique is described on different levels of abstraction with regards to different aspects. That is the zero-latency approach to instantly onboard a (bare metal) client device with a core system image which is for example centrally managed by cloud but provisioned as data blocks to the client by an adjacent edge server. It is also described a zero-latency mechanism to update and restore the client device system software and a system migration approach based on the design.

FIG. 2 illustrates a boot flow comparison of a native PC and a zero-latency approach as described in this disclosure. The boot flow 210, shown on the left hand side of FIG. 2 illustrates the boot flow of a native PC. For native PC or embedded device, after platform hardware is powered on in step 212, it may be taken control of by BIOS and complete the

POST (power-on and self-test) to initialize the hardware to a known state (see step 214). After that, the OS boot loader may be loaded in, from an external storage, for example a local hard disk, into a certain address of system memory and then CPU may jump to this address (see step 216). Then, the OS starts to control the system in step. During the boot period, the OS boot loader may continuously to invoke the BIOS block IO routines such as legacy INT13 or UEFI block IO calls, to read the necessary OS components, such as kernel and correspondent drivers, from the storage to memory (see step 218, 29). When the OS software stack is ready, the entire system may be handed over to the OS (see step 220, 221). During the OS run-time, the OS system software and applications may invoke OS level block read/write SysCalls to fetch data blocks from the local storage.

The boot flow 250 on the right hand side of FIG. 2 illustrates the boot flow of a zero-latency approach as described in this disclosure, which may be carried out by apparatus 100 (for example, by the processing circuitry 130). The processing circuitry 130 may firstly check whether the data block is in local cache (see step 252). If yes, it will pick up there, otherwise from edge server's system image (see steps 254, 256, 258). This may imply that even if there are no data blocks cached at local storage circuitry, the system may still boot step by step by fetching all blocks from remote server just like fetching from local storage. The entire reading and writing of the block IO are transparent to the boot loader and the OS level system and applications. Thereby, the entire system onboarding may have a zero-latency and be kicked off without an image deployment before OS loader. Apparently next time, all data blocks that are stored at local storge circuitry do not need to be picked up from remote again, so this may furtherly improve the efficiency.

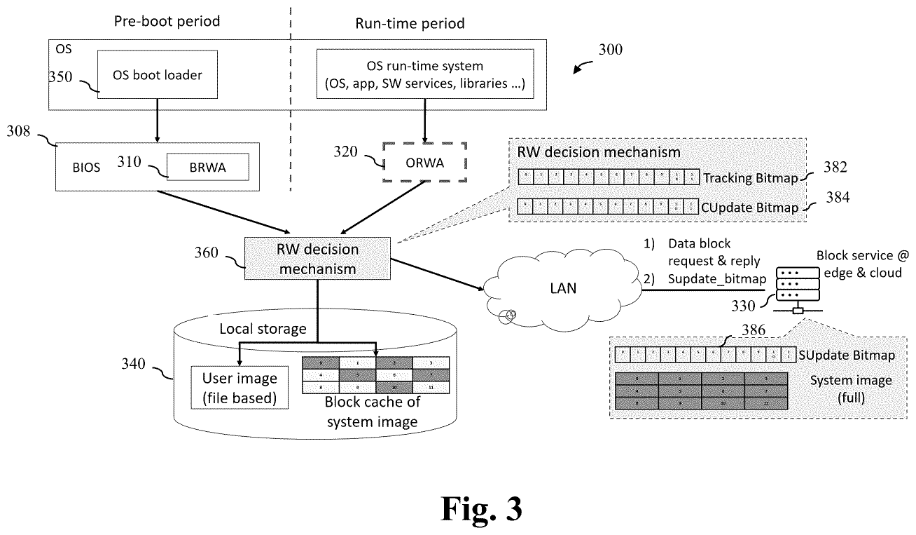

FIG. 3 illustrates an example of a schematic illustration of an internal architecture of a zero-latency onboarding a device 300. The device 300 may carry out the zero-latency onboarding/updating technique as described above. The device 300 is described by functional units in FIG. 3, wherein the functional units illustrate certain functions which may be implemented by different hardware. For example, the functional units of FIG. 3 may be implemented by the processing circuitry 130 of apparatus 100 as described above.

For example, the device 300 includes the functional unit of a BIOS level read-write agent 310 (BRWA) to read/write block data which is input/output from/to the core system image during the pre-boot period. Further, the device 300 includes the functional unit of an OS level read-write agent 320 (ORWA) to read/write block IO data from/to system image during run-time period. The system image (for example comprising the core system image and the user image) may be stored at an edge server 330 which may be centrally managed by a cloud (also referred to as cloud-edge collaboration management). The core system image may be composed of data blocks, which may be partially cached at the local storage circuitry 340 as data blocks. The BRWA 310 may be the BIOS level component that is loaded and residing in memory before the OS loader 350 is running. The BRWA may be part of a BIOS 312, for instance an UEFI BIOS, which may be an UEFI driver. ORWA is an OS level driver beneath the OS instance during run-time. For example, the BRWA and the ORWA may be implemented by the processing circuitry 130. For example, the BRWA may be stored at the storage circuitry 730.

The local storage circuitry 340 at client may comprise the core system image (also referred to as block cache of the system image) to store data blocks of core system image during pre-boot and run-time period. The core system image may be regarded as a subset of system image. Further, the local storage circuitry 340 at client may comprise the file-based user image that which may consist of all user-related application software and user data files. It may be overlayed above the core system image (see also below). For example, the server 330 may comprise a full copy of the system image and/or the core system image.

Further, a read/write (RW) decision mechanism 360 may be comprise a set of policies on where to obtain a requested data block. A data block may be read from/written to the local storage circuitry 340 or from the cloud/edge server 350. Further, the system image at the local storage circuitry 340 and at the cloud/edge server 350 is kept consistent. In order to both read and write, as well as the syncing between client device 300 and server 350 several bitmap files may be used: For example, a tracking bitmap file 382 (also referred to as first data structure above) may be used to track if a specific data block as cached at the local storage circuitry 340. Each data block in core system image may have a single bit in the tracking bitmap and initially all bits were cleared (set to 0). When the OS started to boot and run, the required data blocks were transferred from remote server 330 one by one and cached at local storage 340, and the corresponding bit is set to 1 accordingly. Further, a cupdate bitmap file 384 (also referred to as the third data structure above) may be used to track the core system image updates. That is if a specific data block was modified due to local write/update operations this may be tracked in the cupdate bitmap file 384. If the data block was updated and cached at the local storage 340, e.g., after a write operation, the corresponding bit in the cupdate bitmap file 384 may be set to 1, otherwise it is cleared to 0. Further, at the server side, there may be completed copy of the system image (for example the core system image and/or the user image) which may comprise all data blocks. A supdate bitmap file 386 (also referred to as the second data structure above) may be used to track whether there are any changes required from the server side. That is the supdate bitmap file 386 may be used during the central updating of the core system image at server side. For example, an IT administrator may apply an OS security patch at server 330 and the supdate bitmap file 386 may be deployed from server 330 to client device 330 during booting period. It may be inferred that the bit which is set in cupdate bitmap file 384 may be also set (with 1) in tracking bitmap file 382, because only the data blocks that were cached at the local storage 340 may updated locally.

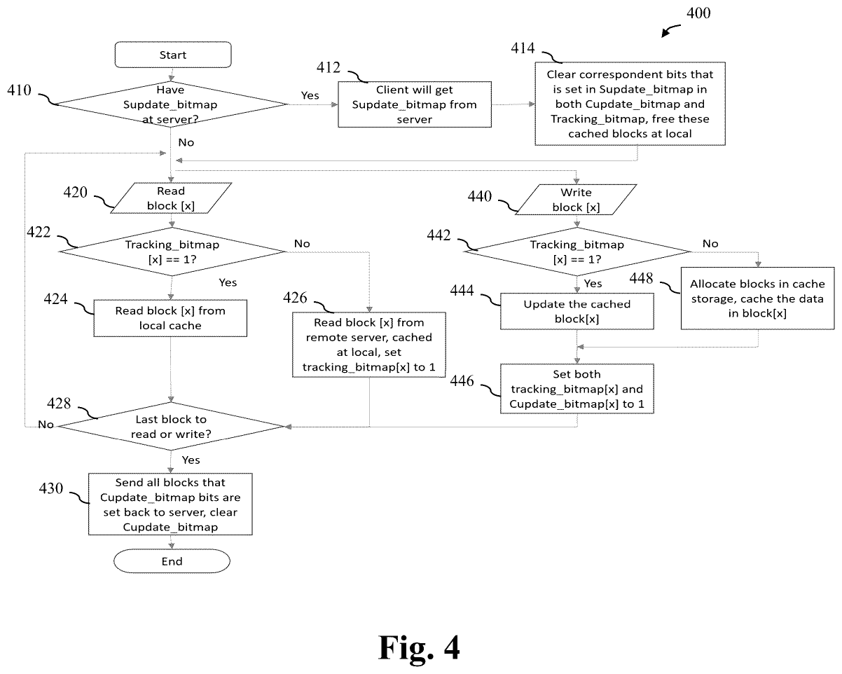

FIG. 4 illustrates an example of a flowchart of the zero-latency read and write method 400. In step 410, the client BRWA (for example implemented by the processing circuitry 130) may check with server whether there are changes to core system image. If yes, then in step 412 the supdate bitmap of server may be deployed to client so that the client knows which data blocks have been updated. In step 414 all correspondent bits that were set in supdate bitmap may be cleared in both, the cupdate bitmap and tracking bitmap at client. The locally cached data blocks are invalidated. Thereafter, when such blocks need to be read/written, it will go to server rather than client cache. In step 420 the read operation starts and in step 440 the write operation starts. Both operations are valid during pre-boot period and run-time period. For example, they may be handled by BRWA and ORWA respectively, which may be implemented by the processing circuitry 130. When a data block [x] is read it is checked in step 422 whether it is cached at the local storage and not updated. If yes, then in step 424 it is read from the local storage. Otherwise, in step 426 the data block will be fetched from remote server and cached at local concurrently. In step 442 it is checked whether a data block [x] to be written is already cached at local storage circuitry. If yes, then in step 444, the data block [x] is updated at the local storage circuitry. If no, then in step 448, the storage space in the local storage circuitry is allocated and the data block [x] is stored there. In step 446, the correspondent bits in the tracking bitmap and cupdate bitmap are set. This indicates that the remote data block [x] in remote backup core system image at the server is not valid and up to date anymore. In step 428 it is checked if the last block is read or written. If yes, then in step 430, the core system image at client and server are synchronized. That is all blocks that are set in cupdate bitmap and the cupdate bitmap itself are sent back to server for the updating of the core system image at server side (cloud). The edge server may be connected to local client via LAN. Hence the network bandwidth and reliability are guaranteed. A copy of the core system image may be placed at edge server for client each connected device to pick up the required data blocks. The reading of data blocks is a run-time fetch, so it does not impact the OS booting and running logically, and consequently this approach has a zero-latency as described above.

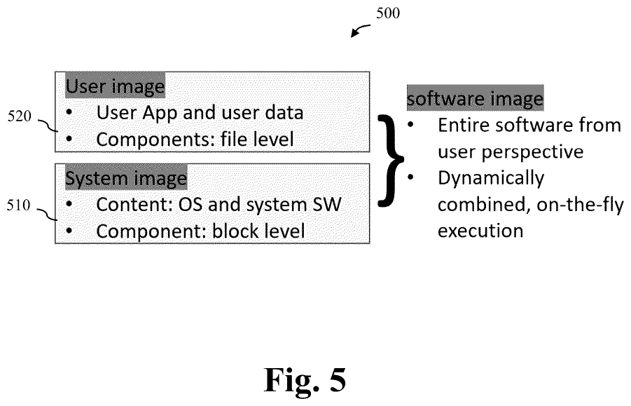

FIG. 5 illustrates a layer of a system image 500. For example, the system image 500 may be virtual disk image which is organized as a two-layer system: The system image 500 comprise a core system image 510. The core system image 510 may be a lower level of system image, which is a block IO based. It may comprise IT-administrator managed content, such as OS, system driver, and pre-installed application software. Further, the system image 500 comprise a user image 520. The user image 520 may be a higher level of system image 500 which may be file based. For example, the user image may comprise content managed by end users, such as user applications software, user data and the personalized settings. The user image 520 may be overlayed over the core system image 510 as described above. By this layered approach an the user may keep his settings, and locally stored data and software configurations when migrating (as described above).

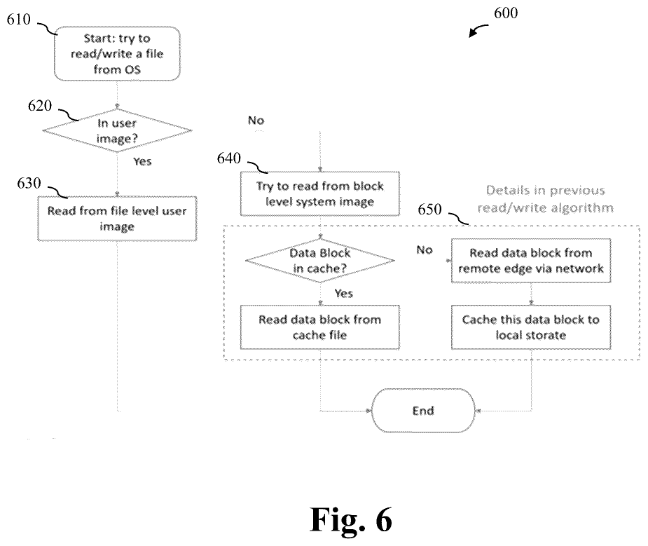

FIG. 6 illustrates an example of a flowchart of an operating system level read/write method. The method may be carried out by the apparatus 100 and/or the processing circuitry 130. In step 610 the method starts. In step 620 it is checked whether a data that is read or written is in the high level user image 520. If yes, then in in step 630 the data may be fetched from user image 510. If no, then in step 640 the data is obtained from the low level core system image 510. This may be done in step 650 as described above, for example in FIG. 4. After individual updates of both low-level system image and high-level user image asynchronously, both images may still be converged.

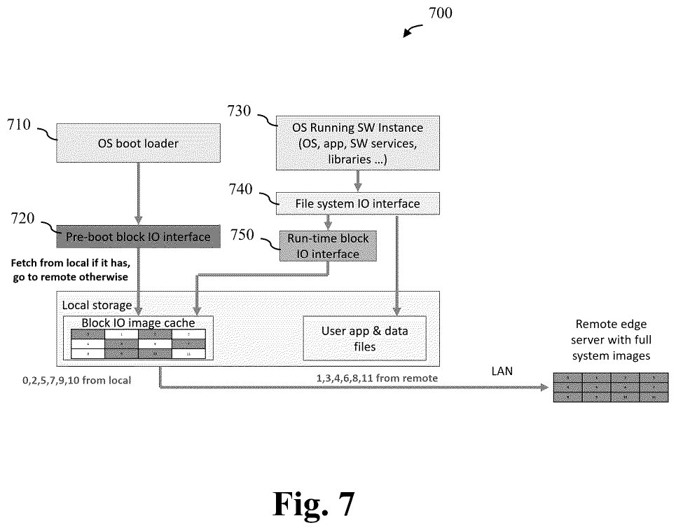

FIG. 7 illustrates an example workflow of the described technique. After hardware power-on, the client device may behave like a native PC during power-on and self-test until the OS boot loader starts to be loaded in step 710. In step 720 It invokes BIOS block IO calls to fetch the block data (which may be handled by BRWA). Then the read/write workflow as described with regards to FIG. 4 may be carried out, to get the data block either from the local storage circuitry or server. Regarding the edge server has the completed system images, no matter it's cached at local, it will return the block data. At the beginning, the local storage circuitry may be empty, and every data block may be fetched from the remote edge server and then cached at the local storage circuitry. During next read of said data block (for example the second boot or OS run-time), may be fetched from the local storage. In step 730 the boot loader may load the OS into the memory and hand the control over to OS. During the run-time period, in steps 740/750 the OS (for example the ORWA, carried out by the processing circuitry 130) may carry out the workflows as described with regards to FIGS. 4 and 6.

The workflow of an updating and upgrading of a system may only comprise operations on the block-level core system image and not on the file-based user image. For example, when a system administrator wants to update the copy of a core system image of a client device stored at an edge server, the updated data blocks are tracked in the updated bitmap file (supdate bitmap). That is each bit of this file indicates whether a respective data block has been updated compared to the old core system image. The bitmap file may be much smaller than the original system core system image file (for example, a 40 GB core system image with block size 1 KB has a 5M byte size bitmap file, so the transport of the bitmap file from edge server to client in an LAN environment is neglectable). The supdate bitmap file may be sent to client device to tell inform the client which blocks have been updated in the copy of the core system image at the server. During the booting of the client device and the OS running period, all data blocks which have been updated at server side were marked as “not tracked” in tracking bitmap file. Then the read/write workflow as described above may be carried out and theses data blocks may be fetched from the server.

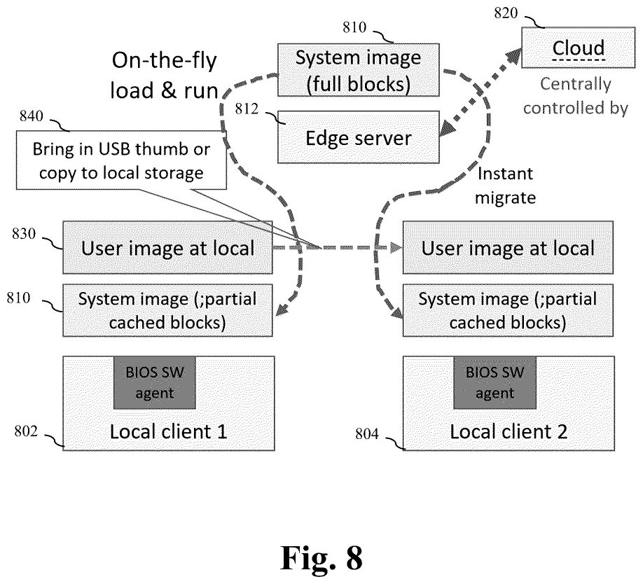

FIG. 8 shows an example of a workflow of a user migration from one device (for example a bare metal client device) to another device (for example a bare metal client device). A copy of the core system image 810 may be stored at the edge server 810 which may be centrally controlled and managed by the cloud 820. Due to the overlay nature of user image 830 and core system image 810 (as described above) in order to migrate the user environment from the first client device 802 to the second client device 804, only the user image 830 needs the be move from client 802 to client 804. The rest of the system image 810, that is the core system image may be “on-the-fly” picked up and executed block by block from the edge server as described above.

For example, a user is using client device 802, where his personal data is in the user image 830, and the system image 810 is centrally stored in edge server 812 and part of the data blocks are cached at the local storage circuitry of the client 802. When the user comes to another client 804, the user image may be copied (for example via a USB thumb or network 840). At the same time, the edge server 812 may set the core system image of client 804 to the corresponding core system image. When the BIOS in client 804 starts to load the system boot loader it (for example the BRWA) may start to pick up data blocks from remote edge server 812, and at the same time cache the obtained blocks at the local storage circuitry of the client 804. This approach does not need to deploy the entire huge system image from client 802 to client 804, so the latency is zero.

The cloud-based service may be dependent on network connection between the client and the backend service in cloud, especially those data intensive cloud services like provisioning that needs to transfer huge amounts of data. To improve the performance and user experience at client side during onboarding, updating, and upgrading, the zero-latency approach as described in the present disclosure may be leveraging the edge server devices. The data provision to client devices may be done through a LAN-connected adjacent edge server, and the system image may be centrally stored and managed in cloud, and on-demand provisioned to correspondent edge devices. This may solve the network bottleneck regarding LAN connection and has a guaranteed network bandwidth, reliability, and latency.

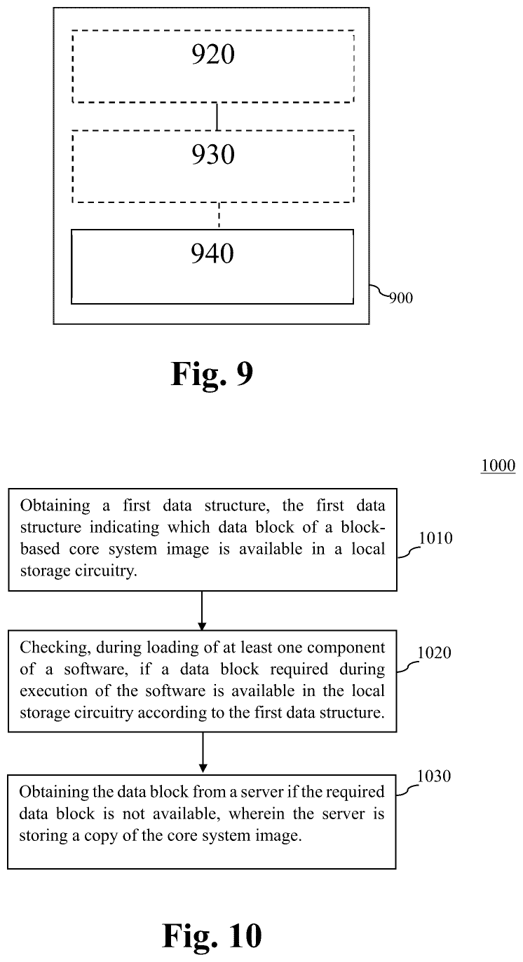

Further details and aspects are mentioned in connection with the examples described above or below. The examples shown in FIGS. 2 to 8 may include one or more optional additional features corresponding to one or more aspects mentioned in connection with the proposed concept or one or more examples described above (e.g., FIG. 1) or below (e.g., FIGS. 9-10).

FIG. 9 illustrates non-transitory machine-readable storage medium 940 including firmware for an apparatus 900 (for example the apparatus 100). The firmware is configured to check, during loading of least one component of a software, if a data block required for executing at least one component of a software, is available in a local storage circuitry. The firmware is further configured to obtain the data block from a server if the required data block is not available. The server is storing a copy of the core system image.

For example, non-transitory machine-readable storage medium 940 may comprise at least one element of the group of a computer readable storage medium, such as a magnetic or optical storage medium, e.g., a hard disk drive, a flash memory, Floppy-Disk, Random Access Memory (RAM), Read Only Memory (ROM), Programmable Read Only Memory (PROM), Erasable Programmable Read Only Memory (EPROM), an Electronically Erasable

Programmable Read Only Memory (EEPROM), or a network storage. For example, firmware may be BIOS, for instance a UEFI BIOS.

In some examples apparatus 904 may further comprise interface circuitry 924 and/or processing circuitry 934. The components apparatus 900 may be implemented different or similar as the components of the apparatus 100.

Further details and aspects are mentioned in connection with the examples described above or below. The example shown in FIG. 9 may include one or more optional additional features corresponding to one or more aspects mentioned in connection with the proposed concept or one or more examples described above (e.g., FIGS. 1 to 8) or below (e.g., FIG. 10).

FIG. 10 illustrates a flowchart of an example of a method 1000. The method 1000 may, for instance, be performed by an apparatus as described herein, such as apparatus 100. The method 1000 comprises obtaining 910 a first data structure (in some examples, the first tracking bitmap may be empty, for example if there are no cached blocks at local storage). The first data structure indicates which data block of a block-based core system image is available in a local storage circuitry. The method 1000 further comprises checking 1020, during loading of at least one component of a software, if a data block required during execution of the software is available in the local storage circuitry according to the first data structure. The method 1000 further comprises obtaining 1030 the data block from a server if the required data block is not available. The server is storing a copy of the core system image.

More details and aspects of the method 1000 are explained in connection with the proposed technique or one or more examples described above, e.g., with reference to FIG. 1. The method 1000 may comprise one or more additional optional features corresponding to one or more aspects of the proposed technique, or one or more examples.

In the following, some examples of the proposed concept are presented:

An example (e.g., example 1) relates to an apparatus comprising interface circuitry, machine-readable instructions and processor circuitry to execute the machine-readable instructions to obtain a first data structure, the first data structure indicating which data block of a block-based core system image is available in a local storage circuitry, check, during loading of at least one component of a software, if a data block required during execution of the software is available in the local storage circuitry according to the first data structure, obtain the data block from a server if the required data block is not available, wherein the server is storing a copy of the core system image.

Another example (e.g., example 2) relates to a previous example (e.g., example 1) or to any other example, further comprising that the processing circuitry is to execute the machine-readable instructions to check, during booting an operating system, if a data block required for booting the operating system is available in the local storage circuitry according to the first data structure.

Another example (e.g., example 3) relates to a previous example (e.g., one of the examples 1 to 2) or to any other example, further comprising that the at least one component of the software is loaded during runtime of an operation system.

Another example (e.g., example 4) relates to a previous example (e.g., one of the examples 1 to 3) or to any other example, further comprising that the at least one component of the software comprises executables of the software and/or the at least one component of the software comprises a data which is used by the software to read/write.

Another example (e.g., example 5) relates to a previous example (e.g., one of the examples 1 to 4) or to any other example, further comprising that the at least one component of the software comprises at least one of an operating system, a system driver, a pre-installed application software, an application, personalized user settings, or a firewall policy.

Another example (e.g., example 6) relates to a previous example (e.g., one of the examples 1 to 5) or to any other example, further comprising that the processing circuitry is to execute the machine-readable instructions to read the required data block from the local storage circuitry if the required data block is available in the local storage circuitry according to the tracking data structure.

Another example (e.g., example 7) relates to a previous example (e.g., one of the examples 1 to 6) or to any other example, further comprising that the local storage circuitry is local to the processor circuitry.

Another example (e.g., example 8) relates to a previous example (e.g., one of the examples 1 to 7) or to any other example, further comprising that the processing circuitry is to execute the machine-readable instructions to obtain a second data structure from the server, the second data structure indicating which data block is to be updated if a data block of the core system image is to be updated.

Another example (e.g., example 9) relates to a previous example (e.g., example 8) or to any other example, further comprising that the processing circuitry is to execute the machine-readable instructions to determine the first data structure based on the second data structure.

Another example (e.g., example 10) relates to a previous example (e.g., one of the examples 8 or 9) or to any other example, further comprising that the processing circuitry is to execute the machine-readable instructions to clear the data block from the local storage circuitry which is indicated in the second data structure to be updated.

Another example (e.g., example 11) relates to a previous example (e.g., one of the examples 8 to 10) or to any other example, further comprising that the processing circuitry is to execute the machine-readable instructions to determine the first data structure based on the second data structure and/or on the data blocks available at the local storage circuitry.

Another example (e.g., example 12) relates to a previous example (e.g., one of the examples 1 to 11) or to any other example, further comprising that the processing circuitry is to execute the machine-readable instructions to write the data block obtained from the server to the local storage circuitry.

Another example (e.g., example 13) relates to a previous example (e.g., example 12) or to any other example, further comprising that the processing circuitry is to execute the machine-readable instructions to update the first data structure, indicating that the written data block is now available in the local storage circuitry.

Another example (e.g., example 14) relates to a previous example (e.g., one of the examples 1 to 13) or to any other example, further comprising that the processing circuitry is to execute the machine-readable instructions to determine a third data structure, the third data structure indicating data blocks that were updated in the local storage circuitry, transmit the third data structure to the server.

Another example (e.g., example 15) relates to a previous example (e.g., one of the examples 1 to 14) or to any other example, further comprising that the processing circuitry is to execute the machine-readable instructions to check if requested data is a data block which is part of the block-based core system image or if the requested data is part of a file-based user image.

Another example (e.g., example 16) relates to a previous example (e.g., one of the examples 1 to 15) or to any other example, further comprising that the core system image comprises at least one of an operating system, a system driver, or pre-installed application software.

Another example (e.g., example 17) relates to a previous example (e.g., one of the examples 1 to 16) or to any other example, further comprising that the first, second and/or third data structure are a bitmap.

Another example (e.g., example 18) relates to a previous example (e.g., one of the examples 1 to 17) or to any other example, further comprising that the server is an edge server.

An example (e.g., example 19) relates to a method comprising obtaining a first data structure, the first data structure indicating which data block of a block-based core system image is available in a local storage circuitry, checking, during loading of at least one component of a software, if a data block required during execution of the software is available in the local storage circuitry according to the first data structure, obtaining the data block from a server if the required data block is not available, wherein the server is storing a copy of the core system image.

Another example (e.g., example 20) relates to a previous example (e.g., example 19) or to any other example, further comprising that the method further comprises checking, during booting an operating system, if a data block required for booting the operating system is available in the local storage circuitry according to the first data structure.

Another example (e.g., example 21) relates to a previous example (e.g., one of the examples 19 to 20) or to any other example, further comprising that the at least one component of the software is loaded during runtime of an operation system.

Another example (e.g., example 22) relates to a previous example (e.g., one of the examples 19 to 21) or to any other example, further comprising that the at least one component of the software comprises executables of the software and/or the at least one component of the software comprises a data which is used by the software to read/write.

Another example (e.g., example 23) relates to a previous example (e.g., one of the examples 19 to 22) or to any other example, further comprising that the at least one component of the software comprises at least one of an operating system, a system driver, a pre-installed application software, an application, personalized user settings, or a firewall policy.

Another example (e.g., example 24) relates to a previous example (e.g., one of the examples 19 to 23) or to any other example, further comprising that the method further comprises reading the required data block from the local storage circuitry if the required data block is available in the local storage circuitry according to the tracking data structure.

Another example (e.g., example 25) relates to a previous example (e.g., one of the examples 19 to 24) or to any other example, further comprising that the local storage circuitry is local to a processor circuitry.

Another example (e.g., example 26) relates to a previous example (e.g., one of the examples 19 to 25) or to any other example, further comprising that the method further comprises obtaining a second data structure from the server, the second data structure indicating which data block is to be updated if a data block of the core system image is to be updated.

Another example (e.g., example 27) relates to a previous example (e.g., example 26) or to any other example, further comprising that the method further comprises determining the first data structure based on the second data structure.

Another example (e.g., example 28) relates to a previous example (e.g., one of the examples 26 or 27) or to any other example, further comprising that the method further comprises clearing the data block from the local storage circuitry which is indicated in the second data structure to be updated.

Another example (e.g., example 29) relates to a previous example (e.g., one of the examples 26 to 28) or to any other example, further comprising that the method further comprises determining the first data structure based on the second data structure and/or on the data blocks available at the local storage circuitry.

Another example (e.g., example 30) relates to a previous example (e.g., one of the examples 19 to 29) or to any other example, further comprising that the method further comprises writing the data block obtained from the server to the local storage circuitry.

Another example (e.g., example 31) relates to a previous example (e.g., example 30) or to any other example, further comprising that the method further comprises updating the first data structure, indicating that the written data block is now available in the local storage circuitry.

Another example (e.g., example 32) relates to a previous example (e.g., one of the examples 19 to 31) or to any other example, further comprising that the method further comprises determining a third data structure, the third data structure indicating data blocks that were updated in the local storage circuitry, transmitting the third data structure to the server.

Another example (e.g., example 33) relates to a previous example (e.g., one of the examples 19 to 32) or to any other example, further comprising that the method further comprises checking if requested data is a data block which is part of the block-based core system image or if the requested data is part of a file-based user image.

Another example (e.g., example 34) relates to a previous example (e.g., one of the examples 1 to 15) or to any other example, further comprising that the core system image comprises at least one of an operating system, a system driver, or pre-installed application software. 35. The method according to any one of examples 1 to 17, wherein the server is an edge server.

An example (e.g., example 36) relates to an apparatus comprising processor circuitry configured to obtain a first data structure, the first data structure indicating which data block of a block-based core system image is available in a local storage circuitry, check, during loading of at least one component of a software, if a data block required during execution of the software is available in the local storage circuitry according to the first data structure, obtain the data block from a server if the required data block is not available, wherein the server is storing a copy of the core system image.

An example (e.g., example 37) relates to a device comprising means for processing for obtaining a first data structure, the first data structure indicating which data block of a block-based core system image is available in a local storage circuitry, checking, during loading of at least one component of a software, if a data block required during execution of the software is available in the local storage circuitry according to the first data structure, obtaining the data block from a server if the required data block is not available, wherein the server is storing a copy of the core system image.

Another example (e.g., example 38) relates to a non-transitory machine-readable storage medium including program code, when executed, to cause a machine to perform method of any one of examples 19 to 35.

Another example (e.g., example 39) relates to a computer program having a program code for performing the method of any one of examples 19 to 35 when the computer program is executed on a computer, a processor, or a programmable hardware component.

Another example (e.g., example 40) relates to a machine-readable storage including machine readable instructions, when executed, to implement a method or realize an apparatus as claimed in any pending examples.

An example (e.g., example 41) relates to a non-transitory machine-readable storage medium including firmware for an apparatus, the firmware being configured to check, during loading of least one component of a software, if a data block required for executing at least one component of a software, is available in a local storage circuitry and obtain the data block from a server if the required data block is not available, wherein the server is storing a copy of the core system image.

The aspects and features described in relation to a particular one of the previous examples may also be combined with one or more of the further examples to replace an identical or similar feature of that further example or to additionally introduce the features into the further example.

Examples may further be or relate to a (computer) program including a program code to execute one or more of the above methods when the program is executed on a computer, processor or other programmable hardware component. Thus, steps, operations or processes of different ones of the methods described above may also be executed by programmed computers, processors or other programmable hardware components. Examples may also cover program storage devices, such as digital data storage media, which are machine-, processor- or computer-readable and encode and/or contain machine-executable, processor-executable or computer-executable programs and instructions. Program storage devices may include or be digital storage devices, magnetic storage media such as magnetic disks and magnetic tapes, hard disk drives, or optically readable digital data storage media, for example. Other examples may also include computers, processors, control units, (field) programmable logic arrays ((F)PLAs), (field) programmable gate arrays ((F)PGAs), graphics processor units (GPU), application-specific integrated circuits (ASICs), integrated circuits (ICs) or system-on-a-chip (SoCs) systems programmed to execute the steps of the methods described above.

It is further understood that the disclosure of several steps, processes, operations or functions disclosed in the description or claims shall not be construed to imply that these operations are necessarily dependent on the order described, unless explicitly stated in the individual case or necessary for technical reasons. Therefore, the previous description does not limit the execution of several steps or functions to a certain order. Furthermore, in further examples, a single step, function, process or operation may include and/or be broken up into several sub-steps, -functions, -processes or -operations.

If some aspects have been described in relation to a device or system, these aspects should also be understood as a description of the corresponding method. For example, a block, device or functional aspect of the device or system may correspond to a feature, such as a method step, of the corresponding method. Accordingly, aspects described in relation to a method shall also be understood as a description of a corresponding block, a corresponding element, a property or a functional feature of a corresponding device or a corresponding system.

As used herein, the term “module” refers to logic that may be implemented in a hardware component or device, software or firmware running on a processing unit, or a combination thereof, to perform one or more operations consistent with the present disclosure. Software and firmware may be embodied as instructions and/or data stored on non-transitory computer-readable storage media. As used herein, the term “circuitry” can comprise, singly or in any combination, non-programmable (hardwired) circuitry, programmable circuitry such as processing units, state machine circuitry, and/or firmware that stores instructions executable by programmable circuitry. Modules described herein may, collectively or individually, be embodied as circuitry that forms a part of a computing system. Thus, any of the modules can be implemented as circuitry. A computing system referred to as being programmed to perform a method can be programmed to perform the method via software, hardware, firmware, or combinations thereof.

Any of the disclosed methods (or a portion thereof) can be implemented as computer-executable instructions or a computer program product. Such instructions can cause a computing system or one or more processing units capable of executing computer-executable instructions to perform any of the disclosed methods. As used herein, the term “computer” refers to any computing system or device described or mentioned herein. Thus, the term “computer-executable instruction” refers to instructions that can be executed by any computing system or device described or mentioned herein.

The computer-executable instructions can be part of, for example, an operating system of the computing system, an application stored locally to the computing system, or a remote application accessible to the computing system (e.g., via a web browser). Any of the methods described herein can be performed by computer-executable instructions performed by a single computing system or by one or more networked computing systems operating in a network environment. Computer-executable instructions and updates to the computer-executable instructions can be downloaded to a computing system from a remote server.

Further, it is to be understood that implementation of the disclosed technologies is not limited to any specific computer language or program. For instance, the disclosed technologies can be implemented by software written in C++, C#, Java, Perl, Python,

JavaScript, Adobe Flash, C#, assembly language, or any other programming language. Likewise, the disclosed technologies are not limited to any particular computer system or type of hardware.

Furthermore, any of the software-based examples (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, cable (including fiber optic cable), magnetic communications, electromagnetic communications (including RF, microwave, ultrasonic, and infrared communications), electronic communications, or other such communication means.

The disclosed methods, apparatuses, and systems are not to be construed as limiting in any way. Instead, the present disclosure is directed toward all novel and nonobvious features and aspects of the various disclosed examples, alone and in various combinations and subcombinations with one another. The disclosed methods, apparatuses, and systems are not limited to any specific aspect or feature or combination thereof, nor do the disclosed examples require that any one or more specific advantages be present or problems be solved.

Theories of operation, scientific principles, or other theoretical descriptions presented herein in reference to the apparatuses or methods of this disclosure have been provided for the purposes of better understanding and are not intended to be limiting in scope. The apparatuses and methods in the appended claims are not limited to those apparatuses and methods that function in the manner described by such theories of operation.

The following claims are hereby incorporated in the detailed description, wherein each claim may stand on its own as a separate example. It should also be noted that although in the claims a dependent claim refers to a particular combination with one or more other claims, other examples may also include a combination of the dependent claim with the subject matter of any other dependent or independent claim. Such combinations are hereby explicitly proposed, unless it is stated in the individual case that a particular combination is not intended. Furthermore, features of a claim should also be included for any other independent claim, even if that claim is not directly defined as dependent on that other independent claim.

What is claimed is:

1. An apparatus comprising interface circuitry, machine-readable instructions and processor circuitry to execute the machine-readable instructions to:
obtain a first data structure, the first data structure indicating which data block of a block-based core system image is available in a local storage circuitry;
check, during loading of at least one component of a software, if a data block required during execution of the software is available in the local storage circuitry according to the first data structure;
obtain the data block from a server if the required data block is not available, wherein the server is storing a copy of the core system image.

2. The apparatus of to claim 1, wherein the processing circuitry is to execute the machine-readable instructions to check, during booting an operating system, if a data block required for booting the operating system is available in the local storage circuitry according to the first data structure.

3. The apparatus of claim 1, wherein the at least one component of the software is loaded during runtime of an operation system.

4. The apparatus of claim 1, wherein the at least one component of the software comprises executables of the software and/or the at least one component of the software comprises a data which is used by the software to read/write.

5. The apparatus of claim 1, wherein the at least one component of the software comprises at least one of an operating system, a system driver, a pre-installed application software, an application, personalized user settings, or a firewall policy.

6. The apparatus of claim 1, wherein the processing circuitry is to execute the machine-readable instructions to read the required data block from the local storage circuitry if the required data block is available in the local storage circuitry according to the tracking data structure.

7. The apparatus of claim 1, wherein the local storage circuitry is local to the processor circuitry.

8. The apparatus of claim 1, wherein the processing circuitry is to execute the machine-readable instructions to obtain a second data structure from the server, the second data structure indicating which data block is to be updated if a data block of the core system image is to be updated.

9. The apparatus according to claim 8, wherein the processing circuitry is to execute the machine-readable instructions to determine the first data structure based on the second data structure.

10. The apparatus according to claim 8, wherein the processing circuitry is to execute the machine-readable instructions to clear the data block from the local storage circuitry which is indicated in the second data structure to be updated.

11. The apparatus according to claim 8, wherein the processing circuitry is to execute the machine-readable instructions to determine the first data structure based on the second data structure and/or on the data blocks available at the local storage circuitry.

12. The apparatus of claim 1, wherein the processing circuitry is to execute the machine-readable instructions to write the data block obtained from the server to the local storage circuitry.

13. The apparatus according to claim 12, wherein the processing circuitry is to execute the machine-readable instructions to update the first data structure, indicating that the written data block is now available in the local storage circuitry.

14. The apparatus of claim 1, wherein the processing circuitry is to execute the machine-readable instructions to
determine a third data structure, the third data structure indicating data blocks that were updated in the local storage circuitry;
transmit the third data structure to the server.

15. The apparatus of claim 1, wherein the processing circuitry is to execute the machine-readable instructions to check if requested data is a data block which is part of the block-based core system image or if the requested data is part of a file-based user image.

16. The apparatus of claim 1, wherein the core system image comprises at least one of an operating system, a system driver, or pre-installed application software.

17. The apparatus of claim 1, wherein the first, second and/or third data structure are a bitmap.

18. The apparatus of claim 1, wherein the server is an edge server.

19. A method comprising:
obtaining a first data structure, the first data structure indicating which data block of a block-based core system image is available in a local storage circuitry;
checking, during loading of at least one component of a software, if a data block required during execution of the software is available in the local storage circuitry according to the first data structure;
obtaining the data block from a server if the required data block is not available, wherein the server is storing a copy of the core system image.

20. A non-transitory machine-readable storage medium including firmware for an apparatus, the firmware being configured to check, during loading of least one component of a software, if a data block required for executing at least one component of a software, is available in a local storage circuitry and obtain the data block from a server if the required data block is not available, wherein the server is storing a copy of the core system image
